(19) United States
(12) Patent Application Publication
(10) Pub. No.: US 2007/0028164 A1
(43) Pub. Date: Feb. 1, 2007

(54) Computer readable storage medium and document processing method

(75) Inventor: Hirokazu Kawanishi, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/251,677

(22) Filed: Oct. 17, 2005

(30) Foreign Application Priority Data
Jul. 26, 2005 (JP) 2005-215478

(51) Int. Cl. G06F 17/00; G06F 9/45

(52) U.S. Cl. 715/515; 715/513; 715/523; 717/136

(57) ABSTRACT

The present invention provides a signal for carrying a document processing program for making a computer process a document with a mixture of descriptions of first and second languages, wherein the program makes the computer carry out at least one of a first process of converting the description by the second language into comment syntax of the first language in a state where identifier information is added; and a second process of converting the description of the second language into an escape character string defined by the first language.

### BACKGROUND OF THE INVENTION

1. Field of the Invention

The present invention relates to a document processing program, document processing method and computer readable storage medium, and in particular to an effective technique applicable to a document processing technique of a development process, et cetera, of a Web application.

2. Description of the Related Art

In recent years, various Web applications have been implemented by distributing, on the server side, a dynamic page document (e.g., JSP (Java Server Pages), ASP (Active Server Pages), et cetera) embedding a general purpose programming language represented by Java™ language, et cetera, which does not depend on the platform in an HTML (Hyper Text Markup Language) document; creating an HTML document automatically by executing the general purpose programming language embedded in the HTML document according to a request from a Web client; and transmitting the created HTML document to the Web client.

According to such a dynamic page document technique, various Web applications can be built up relatively easily without furnishing a Web browser with special functions on the client side, because an execution result on the server side is expressed in standard HTML format.

Incidentally, HTML is for controlling display design by embedding tags in text information, and allows a user having no special programming knowledge, et cetera, to readily create an HTML document with a desired display design. Various kinds of editing software are on the market, making it possible to create an HTML document by simple operations as if operating a word processor.

In contrast, handling a general purpose programming language embedded in a dynamic page document requires knowledge of programming. Therefore, the general practice is that the creation of a dynamic page document is carried out by an expert engineer with knowledge of programming.

As such, since there are many cases where a person responsible for a dynamic page document using a technique such as JSP does not possess programming skills, such a person cannot customize the dynamic page document, requiring a person responsible for programming to modify it according to each requirement each and every time.

And in a dynamic page document in which there is a mixture of HTML and general purpose programming language descriptions, displaying a dynamic page document in browser software, such as a web browser, or editor software for the purpose of an operation for changing designs causes the general purpose programming language to become noise, resulting in a inaccurate display state, preventing accurate confirmation of design.

Therefore, the development and maintenance of Web applications using a dynamic page document technique requires a skilled engineer to work at a source code level, hence the problem of low development efficiency.

For instance, if there is a need to modify, according to a requirement, such as the design of a dynamic page document as a base which has been created in cooperation between programming personnel and design personnel, it is likely that the design personnel requesting modification does not possess programming skills and therefore will have difficulty in modifying the design described in the dynamic page document.

As for the development of dynamic page documents, in the case of creating various dynamic page documents in which embedded logic of a general purpose programming language is common and the display designs of the output HTML documents are different, the creation of all such documents requires the involvement of engineer (s) comprehending the programming, thus increasing the development cost.

That is, conventional techniques face difficulty because of the separation of operations of design and logic programming, hence making it difficult to improve development efficiency and maintenance the efficiency of a dynamic page document.

In the meantime, the highly versatile XML (Extensible Markup Language) is used as a medium for exchanging an HTML document or a dynamic page document between various kinds of application software. In this case, when application software handles an XML document, the general practice is to use an XML parser (e.g., DOM (Document Object Model), SAX (the Simple API for XML) or XSLT (Extensible Stylesheet Language Transformation)), which at the time of conversion simultaneously examines whether or not the XML document is correctly structured in light of a grammar, instead of reading the XML document directly.

The XML parser such as a DOM, SAX or XSLT has a compulsory requirement for inputting a so-called well-formed XML document. Due to this, if an output expression of a general purpose programming language embedded in a dynamic page document exists within one HTML tag (e.g., <a href=“test.jsp?id=<%=id%>”>return</a>), it is not possible to convert it into a target document format because it does not result in a well-formed XML document.

A conceivable countermeasure to this problem is to use a CDATA section which is a mechanism for making the parser recognize a reserved word or special characters of the XML. That is, it is possible to solve the above problem by using a CDATA section to change the above described code to <![CDATA[<a href=“test.jsp?id=<%=id%>”>return</a>]]>.

However, if it is not possible to use a CDATA section for a certain condition, the technical problem that a description of the general purpose programming language embedded in a dynamic page document becomes an obstacle to the XML parser arises.

Incidentally, a patent document 1 has disclosed a technique for as a result of analysis, moving information about a leaf element of a tree structure into the start tag of a parent element as an attribute of the aforementioned parent element of the aforementioned leaf element during the process of a parser analyzing a structured document such as an XML document, thereby compressing the tag part without losing a characteristic of a structured document and improving the compression ratio of thereof. But recognition of the above described problem is not evident therein.

Meanwhile, a patent document 2 has disclosed a technique for generating a business class group inheriting an output class which possesses a name mapping method and a value acquisition method and applying various dynamic embedding for a value acquisition to an HTML document, thereby automatically creating JSP which enables dynamic value acquisition from an embedded HTML document by using a value acquisition method of an output class. However, the above described technical problem associated with a change, et cetera, of the JSP after creation is not recognized.

[Patent Document 1] laid-open Japanese patent application publication No. 2001-67348

[Patent Document 2] laid-open Japanese patent application publication No. 2003-316575

### SUMMARY OF THE INVENTION

A purpose of the present invention is to provide document processing capable of improving development and maintenance efficiency of a dynamic page document.

Another purpose of the present invention is to provide a document processing technique capable of converting accurately a document described in a mixture of first and second languages by using a third language as a medium.

A first aspect of the present invention is to provide a computer readable storage medium storing a document processing program for making a computer process a document with a mixture of descriptions by first and second languages, wherein the program makes the computer carry out at least one of a first process of converting the description by the second language into comment syntax of the first language in a state where identifier information is added; and a second process of converting the description by the second language into an escape character string defined by the first language.

A second aspect of the present invention is to provide a computer readable storage medium storing a document processing program for making a computer process a document with a mixture of descriptions by first and second languages, wherein the program makes the computer carry out at least one of a first process of restoring, the description by the second language, the description by the second language which is embedded in comment syntax of the first language in a state where identifier information is added, and second process of restoring, to a pre-conversion state, said description by the second language which is converted to an escape character string defined by the first language.

A third aspect of the present invention is to provide a document processing method for processing a document with a mixture of descriptions by first and second languages, comprising a first step of carrying out at least one of a first process for converting the description by the second language into comment syntax of the first language in a state where identifier information is added and a second process of converting the description by the second language into an escape character string defined by the first language; and a second step of carrying out at least one of a third process for restoring, to the said description by the second language, said description by the second language which is embedded in comment syntax of the first language in a state where identifier information is added, a fourth process of restoring, to a pre-conversion state, the description by the second language which is converted to an escape character string defined by the first language, and a fifth process of converting said description by said first language to a description by a third language.

According to the above described present invention, converting a description by a second language mixed with a description of a first language into comment syntax of the first language in a dynamic page document with a mixture of descriptions of the first and second languages for example completely eliminates a need to be conscious of the description of the second language, such as a general purpose programming language in the display or editing work of a description by HTML as the first language for example.

Also, converting a description of the second language affecting the display design of a description of the first language into an escape character string for instance, prevents the display design of the first language from being distorted, thereby making it possible to create an accurate display design and carry out change processing.

That is, it is possible to separate between design accomplished by the fist language and logic accomplished by the second language definitely, and allow a user without a knowledge of programming to easily change the design of a dynamic page document during creation and change of a dynamic page document, hence improving the development and maintenance efficiencies of the dynamic page document.

And, the addition of identifier information when converting a description of the second language to comment syntax of the first language makes it possible to restore the description of the second language accurately after creating or changing a description of the first language for instance.

Also, when a dynamic page document with a mixture of descriptions of the first and second languages is converted to another document with a third language as the medium, which includes the specification of the first language, an influence of the description of the second language on a grammatical analysis of the third language is prevented so as to convert a document with a mixture of descriptions of the first and second languages with the third language as the medium accurately.

### BRIEF DESCRIPTION OF THE DRAWINGS

FIG. 1 is a flow chart exemplifying an operation of a document processing technique according to an embodiment of the present invention;

FIG. 2 is a flow chart exemplifying an operation of a document processing technique according to an embodiment of the present invention;

FIG. 3 is a flow chart exemplifying an operation of a document processing technique according to an embodiment of the present invention;

FIG. 4 is a conceptual diagram exemplifying a configuration of an information processing system for carrying out a document processing technique according to an embodiment of the present invention;

FIG. 5 is a block diagram exemplifying a configuration of a server apparatus constituting an information processing system according to an embodiment of the present invention;

FIG. 6 is a description chart showing an example data format of a dynamic page document used in a document processing technique according to an embodiment of the present invention;

FIG. 7 exemplifies content of an original dynamic page document as a subject of processing by a document processing technique according to an embodiment of the present invention;

FIG. 8 shows example content of an HTML document as a result of executing an original dynamic page document;

FIG. 9 is a description chart showing a display result of an HTML document as a result of executing an original dynamic page document;

FIG. 10 shows a content example of a model HTML document obtained from an original dynamic page document;

FIG. 11 showing a display state of a model HTML document;

FIG. 12 shows a content example, after a design change, of a model HTML document obtained from an original dynamic page document;

FIG. 13 is a description chart showing the display state of a model HTML document after a design change;

FIG. 14 exemplifies a model HTML document after a design change which has been converted to an XML document;

FIG. 15 is a description chart showing a display state of a model HTML document after a design change which has been converted to an XML document;

FIG. 16 shows content of the dynamic page document final output after a design change;

FIG. 17 shows a content example of an HTML document obtained as a result of executing the dynamic page document final output;

FIG. 18 is a description chart showing a display state of an HTML document obtained as a result of executing the dynamic page document final output;

FIG. 19 is a conceptual diagram showing a modified example of a document processing technique as an embodiment of the present invention;

FIG. 20 exemplifies an XSLT style sheet used by the modified example of embodiment of the present invention;

FIG. 21 shows a content example of an original dynamic page document as an input to an XSLT;

FIG. 22 shows a content example of an HTML document as a result of executing an original dynamic page document as an input to an XSLT;

FIG. 23 is a description chart showing a display state of an HTML document as a result of executing an original dynamic page document as an input to an XSLT;

FIG. 24 shows content of an original dynamic page document which has been converted into a well-formed XML document;

FIG. 25 shows content of a dynamic page document which has been converted by XSLT;

FIG. 26 shows content of an HTML document obtained as a result of executing a dynamic page document which has been converted by XSLT; and

FIG. 27 is a description chart showing a display state of an HTML document obtained as a result of executing a dynamic page document which has been converted by XSLT.

### DESCRIPTION OF THE PREFERRED EMBODIMENTS

The following is a detailed description of the preferred embodiment of the present invention while referring to the accompanying drawings.

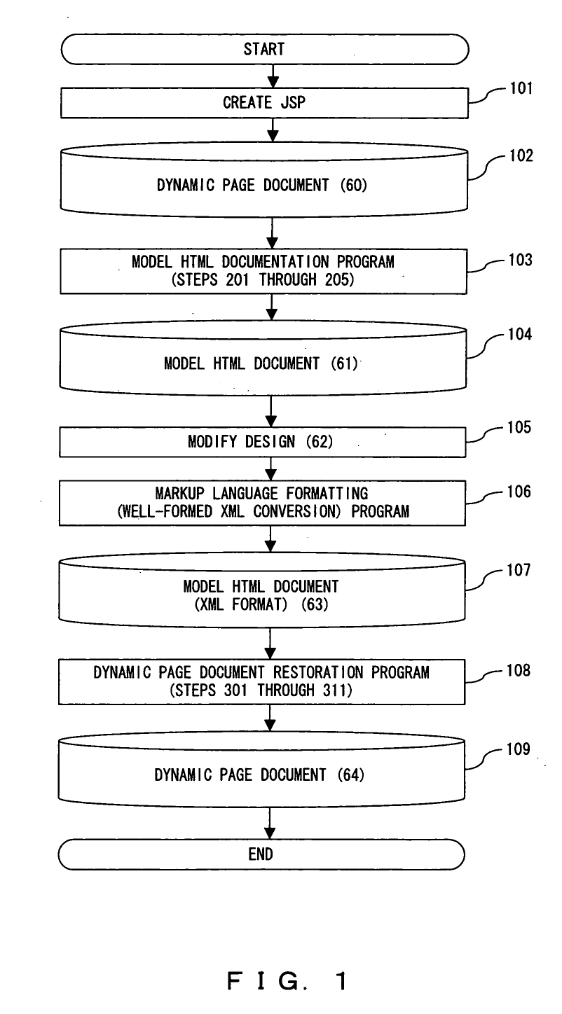

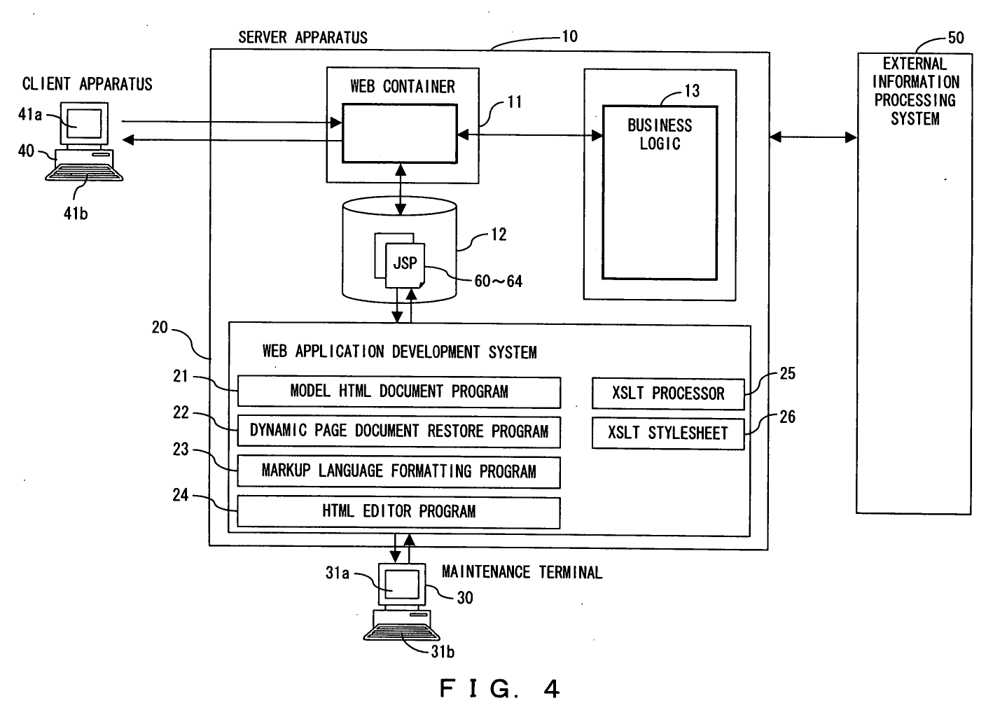

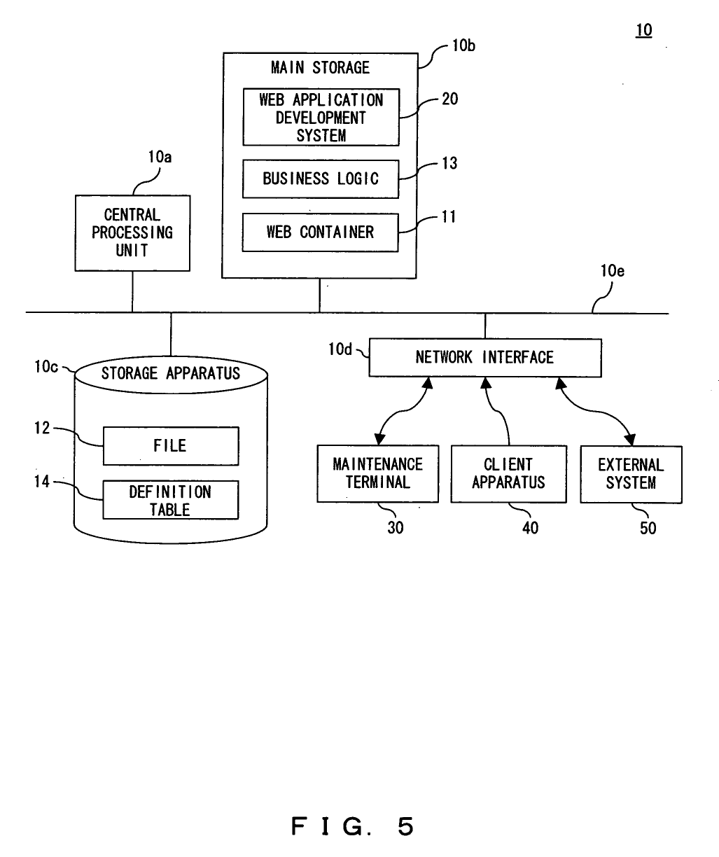

FIGS. 1, 2 and 3 each show a flow chart exemplifying an operation of a document processing technique according to an embodiment of the present invention; FIG. 4 is a conceptual diagram exemplifying a configuration of an information processing system for carrying out a document processing technique according to the present embodiment; and FIG. 5 is a block diagram exemplifying a configuration of a server apparatus constituting an information processing system according to the present embodiment.

As exemplified by FIG. 4, an information processing system according to the present embodiment includes a server apparatus 10, a maintenance terminal 30, a client apparatus 40, an external system 50 and an information network (not shown herein) such as the Internet and/or a LAN (local area network) interconnecting the aforementioned components.

As exemplified by FIG. 5, the server apparatus 10 according to the present embodiment comprises a central processing unit 10a, main storage 10b, a storage apparatus 10c, a network interface 10d and a bus 10e.

The central processing unit 10a executes software stored by the main storage 10b, thereby carrying out a later described information processing.

The main storage 10b stores the software and data to be accessed by the central processing unit 10a.

The storage apparatus 10c, being constituted by a nonvolatile storage medium such as a semiconductor memory or a disk storage apparatus, stores information such as files 12.

The network interface 10d provides a control interface for the network connection among a server apparatus 10, maintenance terminal 30, client apparatus 40 and external system 50.

The bus 10e is an information transmission path for interconnecting each component of the network interface 10d to the central processing unit 10a.

In the case of the present embodiment, the main storage 10b is installed by a Web container 11, file 12, business logic 13, and Web application development system 20 so as to carry out processing, exemplified by a later described series of flow charts, by the central processing unit 10a executing the aforementioned collection of software.

That is, the Web container 11, being software functioning as Web server, accomplishes a necessary Web application by executing a program such as a Servlet which is generated from a later described dynamic page document (i.e., a later described original dynamic page document 60), et cetera, such as a JSP stored by the file 12.

The business logic 13, residing between the external system 50 made up of a data base system for example and Web container 11, controls information exchange therebetween.

The file 12 stores an original dynamic page document 60, a model HTML document 61, a post-edit model HTML document 62, a post-well-formed model HTML document 63 or a post-restore dynamic page document 64, all of which are described later, in addition to information required by the Web container 11.

In the case of the present embodiment, the original dynamic page document 60 stored by the file 12 is developed and maintained by the Web application development system 20.

The Web application development system 20 includes a software suite, e.g., a model HTML document program 21, a dynamic page document restore program 22, a markup language formatting program 23, an HTML editor program 24, an XSLT processor 25, and an XSLT Stylesheet 26.

The Web application development system 20 is operated by the maintenance terminal 30 accessing the server apparatus 10 by way of an information network (not shown herein).

The maintenance terminal 30 is equipped with user interfaces such as a display 31a and keyboard 31b, and is installed with software such as a Web browser 32.

A system manager controls the Web application development system 20 by operating the maintenance terminal 30, and develops and maintains Web applications such as the original dynamic page document 60 by accessing the file 12 by way of the Web container 11.

The model HTML document program 21 has, for example, the functions of converting a general purpose programming language description 90 such as JSP which is mixed in an HTML description 80 of an HTML document into a special comment node 85 of the HTML description 80, and converting a specific character string of an output expression 91 mixed in the general purpose programming language description 90 into an escape character string 84, as described later.

Conversely, the dynamic page document restore program 22 restores part of the HTML description 80, which has been converted by the model HTML document program 21, back to the original state.

The markup language formatting program 23 performs the processing of reformatting an empty element tag which is included in the HTML description 80 and possesses only a start tag 82 to the state of conforming to an XML format for example, as described later.

The HTML editor program 24 is software for editing the original dynamic page document 60 including the HTML description 80. Note that the HTML editor program 24 comprises an XML parser and handles documents conforming to the XML format according to the present embodiment.

The XSLT processor 25 performs the processing of converting a document conforming to the XML format into one of a desired display style or format by using the XSLT (Extensible Stylesheet Language Transformation; an XML Style language) based on a definition described in the XSLT Stylesheet 26.

The XSLT Stylesheet 26 has the description of a series of definitions for XSLT used by the XSLT processor.

The client apparatus 40, comprising user interfaces such as a display 41a and keyboard 41b and being installed with software such as a Web browser 42, sends a request to the Web container 11 comprised by the server apparatus 10 and displays an HTML document or an XML document according to a response to the aforementioned request, thereby carrying out business processing such as a search, et cetera, of a database furnished in the external system 50 for example.

The following description describes an example operation of the present embodiment.

The first description is of a generic operation of the information processing system exemplified by FIG. 4. Having received a request from the client apparatus 40, the Web container 11 comprised by the server apparatus 10 executes a dynamic page document such as the original dynamic page document 60, thereby automatically creating an HTML document or XML document, at each execution, including information obtained from the external system 50 by way of the business logic 13, for example, and transmitting the created document to the client apparatus 40.

The Web browser 42 installed on the client apparatus 40 displays the received HTML document, thereby displaying the information obtained from the external system 50.

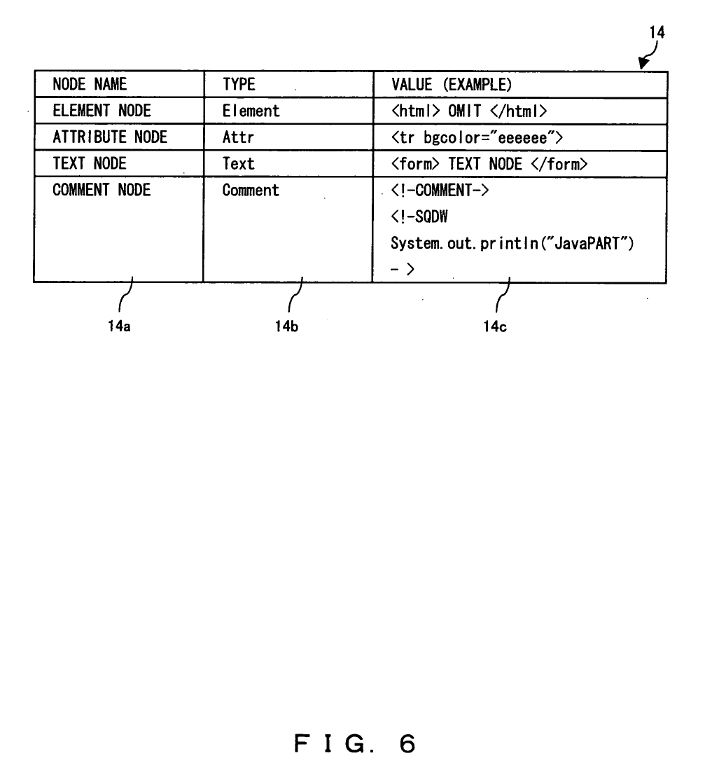

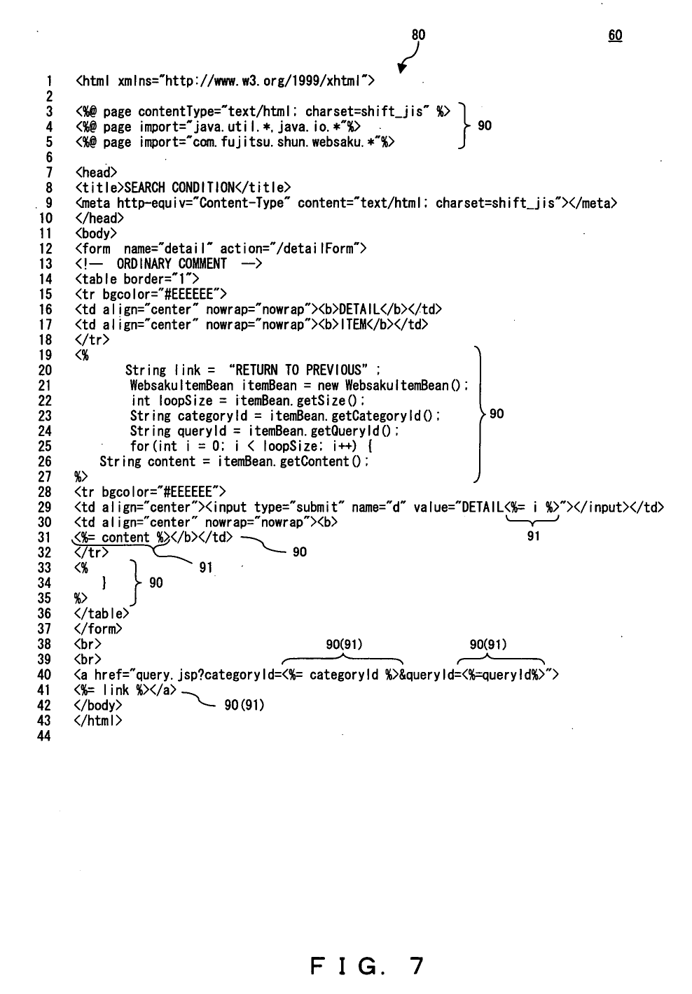

FIG. 6 is a description chart showing an example data format of the original dynamic page document 60 used as described above; while FIG. 7 exemplifies content of an original dynamic page document 60. Incidentally, FIG. 7 shows line numbers for convenience of reference. The same practice is used in all drawings exemplifying the source code of a document.

A definition table 14 shown by FIG. 6 consists of a node name 14a, type 14b and value 14c with the correlation among the aforementioned three items being defined. The node name 14a registers an element node 81a, an attribute node 81b, a text node 81c and a comment node 81d. Note that the comment node 81d includes a later described special comment node 85 in the case of the present embodiment.

The original dynamic page document 60 exemplified by FIG. 7 has a mixture of the element node 81a which is defined by the definition table 14 shown by FIG. 6 and described by a start tag 82, end tag 83, et cetera; the HTML description 80 including an attribute node 81b, text node 81c, comment node 81d, et cetera; and the general purpose programming language description 90 described by the Java language, et cetera.

For example, the general purpose programming language description 90 is written in the line numbers 3 through 5, 19 through 27, 31, 33 through 35 and 41 in the original dynamic page document 60 exemplified by FIG. 7.

And the output expression 91 of the general purpose programming language description 90 is mixed within the line of the attribute node 81b of the HTML description 80 in the line numbers 29, 31 and 40.

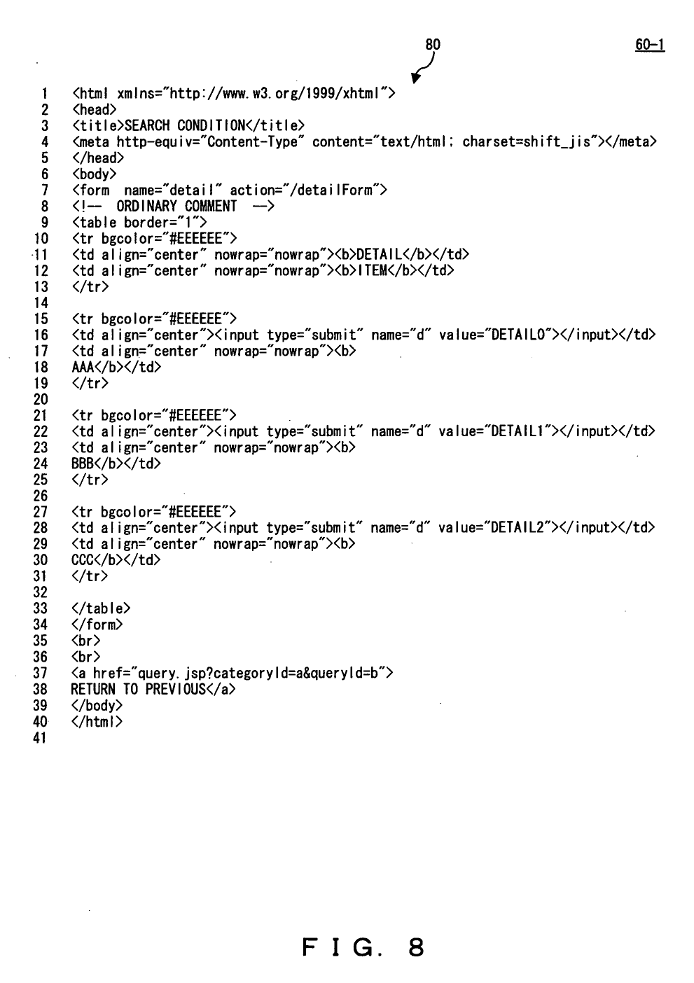

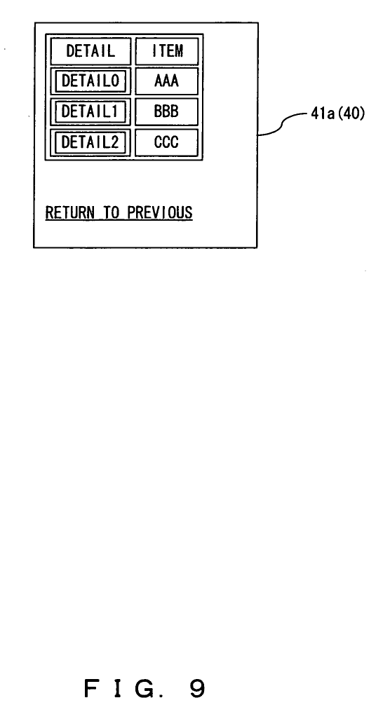

An original output HTML document 60-1 exemplified by FIG. 8 is an HTML document created by executing the original dynamic page document 60. And FIG. 9 shows the display state when the original output HTML document 60-1 is displayed in the Web browser 42 installed on the client apparatus 40.

That is, in the general purpose programming language description 90 of the original dynamic page document 60, the number of loops is substituted for the variable “i” by the loop of the line numbers 25 through 34; the value is associated with a character string “detail” and then substituted for a variable, i.e., “value”; output by the output expression 91 as an HTML description 80 (at the line number 29); and character strings (i.e., “AAA”, “BBB” and “CCC” in this case) as a result of substituting sequentially for a variable “content” in the line number 26 are output by the output expression 91 in the line number 31 as an HTML description 80.

An HTML document dynamically created from the original dynamic page document 60 is the original output HTML document 60-1.

In such an original dynamic page document 60, if a display design is either changed or modified by changing a part of the HTML description 80 by using an HTML editor program 24 while maintaining the logic according to the general purpose programming language description 90, the general purpose programming language description 90 part is judged as an error in the analysis process by the XML parser of the HTML editor program 24 or the display style by the HTML description 80 is disturbed.

Accordingly, the present embodiment is configured to process the original dynamic page document 60 by using the model HTML document program 21 and dynamic page document restore program 22 before and after editing the original dynamic page document 60, thereby rendering the general purpose programming language description 90 harmless at the HTML level (i.e., well-forming) and restoring as described in the following.

That is, as exemplified by FIG. 1, a technician with a knowledge of the HTML description 80 and general purpose programming language description 90 for example creates an original dynamic page document 60 (step 101) to be stored in a file 12 (step 102).

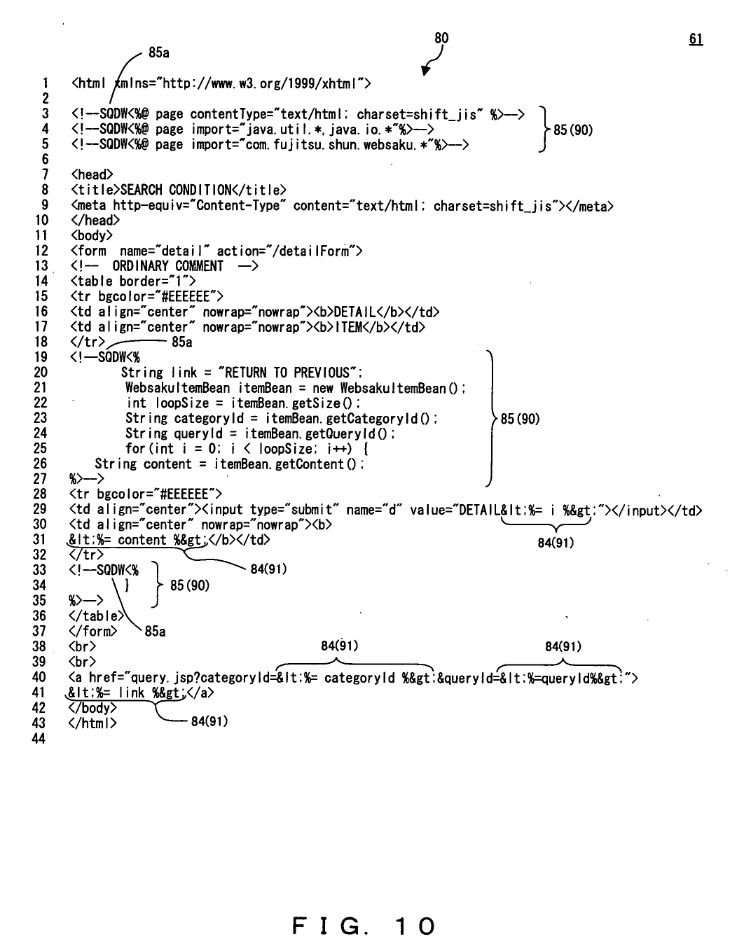

Usually the original dynamic page document 60 is used as is (e.g., the above described FIGS. 8 and 9), but if a change is required to the HTML description 80, the present embodiment is configured to process as described in the following, thereby creating a model HTML document 61 exemplified by FIG. 10 (step 103) to store in the file 12 (step 104).

In other words, the first step is to surround, by a special comment node 85, the general purpose programming language description 90 part (i.e., program code) included in the original dynamic page document 60 as a base by using the model HTML document program 21. The special comment node 85 is embedded with comment identifier information 85a (i.e., a character string “SQDW” in this case), thereby making it possible to distinguish it from an ordinary comment node 81d.

Furthermore, the model HTML document program 21 converts each of “<” and “>” within the output expression 91 to an escape character string 84 of the HTML description 80 (i.e., “&lt” and “&gt”).

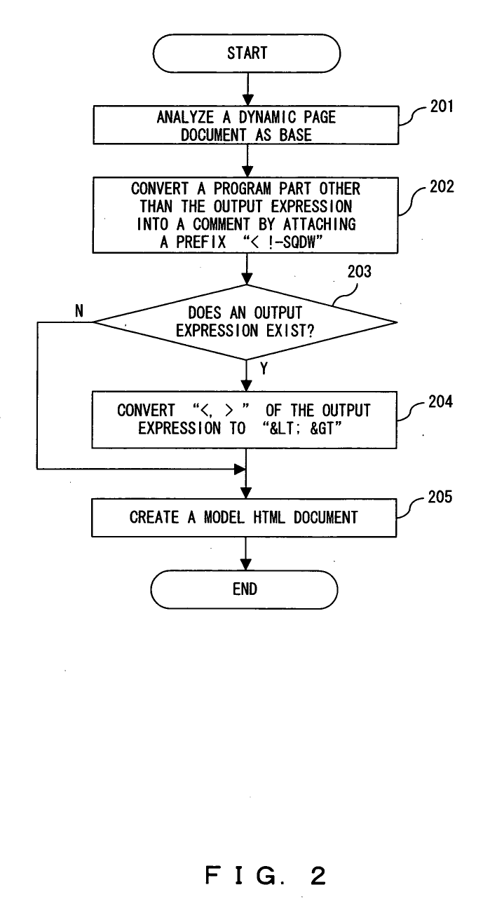

FIG. 2 shows a flow chart of the processing by the model HTML document program 21.

That is, the model HTML document program 21 analyzes an input original dynamic page document 60 based on the data format shown by FIG. 6 (step 201), converts the general purpose programming language description 90 other than the output expression 91 into a special comment node 85 (step 202), further judges the presence or absence of the output expression 91 (step 203) and, if the output expression 91 is present, converts each of “<” and “>” within the output expression 91 into an escape character string 84 of the HTML description 80 (i.e., “&lt” and “&gt”) (step 204) to output as a model HTML document 61 (step 205). As a result of the processing by the model HTML document program 21, the model HTML document 61 has become well-formed at the XML level.

The next step is to edit the thus obtained model HTML document 61 at the maintenance terminal 30 by using the HTML editor program 24 (step 105). In this event, an analysis of the model HTML document 61 is carried out by the built in XML parser, et cetera, on starting the HTML editor program 24, but in the present embodiment the general purpose programming language description 90 mixed in the HTML description 80 is rendered harmless to become well-formed by the special comment node 85 and escape character string 84 as described above, and therefore errors such as analysis errors do not occur.

Meanwhile, converting the “<” and “>” of the output expression 91 of the general purpose programming language description 90 into an escape character string 84 enables editing without adversely affecting the display aspect of the aforementioned output expression 91.

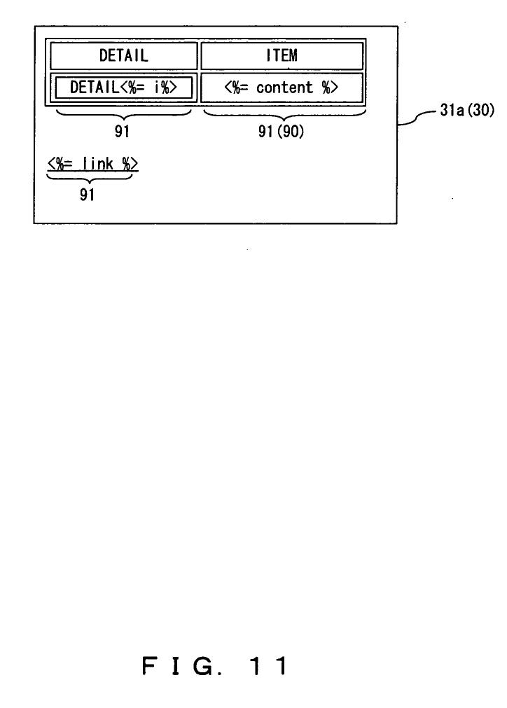

That is, FIG. 11 shows a state of displaying a model HTML document 61 shown by FIG. 10 in the Web browser 32 installed at the maintenance terminal 30, in editing a model HTML document 61 by the HTML editor program 24.

Conversion of the “<” and “>” of the output expression 91 into an escape character string 84 displays a character string of the output expression 91 as is in the display data part by the aforementioned output expression 91, thereby making it easy to make an image of the actual display position and display content, and hence easy to edit.

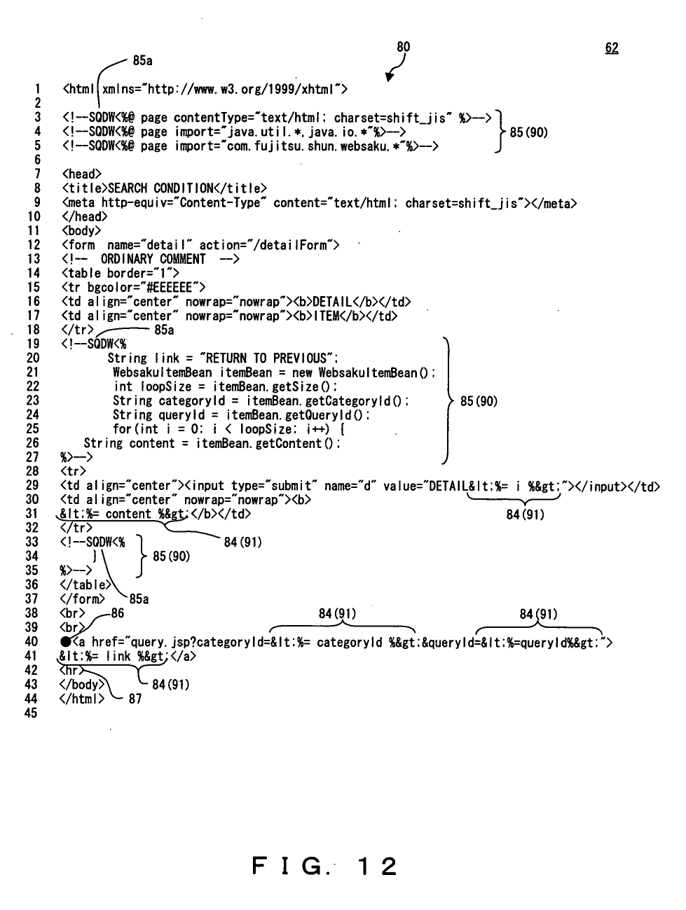

FIG. 12 shows content of a post-edit model HTML document 62 as a result of an actual design change to a model HTML document 61. In the example shown by FIG. 12, a character 86 of “●” is added to the head of the line number 40, and an empty element tag 87 “<hr>” for displaying a horizontal line 87a on the display is added to line number 42.

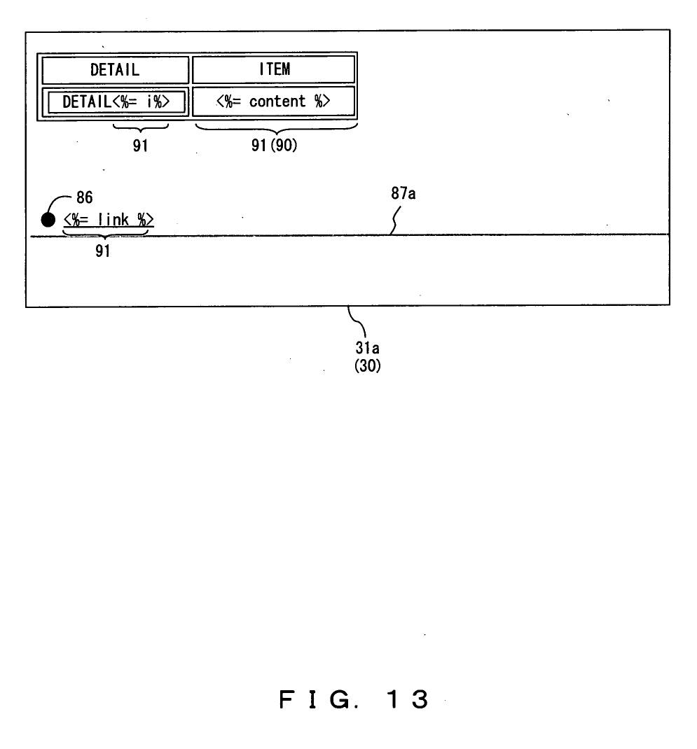

By so doing, the display state of the post-edit model HTML document 62 becomes as shown by FIG. 13, showing the character 86 “●” and horizontal line 87a. As such, it is possible to confirm accurately the display state of an HTML description 80 after a change, without being influenced by the general purpose programming language description 90.

Upon finishing such editing, the present embodiment reformats empty element tags, et cetera, included in the post-edit model HTML document 62 (step 106), and outputs a post-well-formed model HTML document 63 in XML format (step 107).

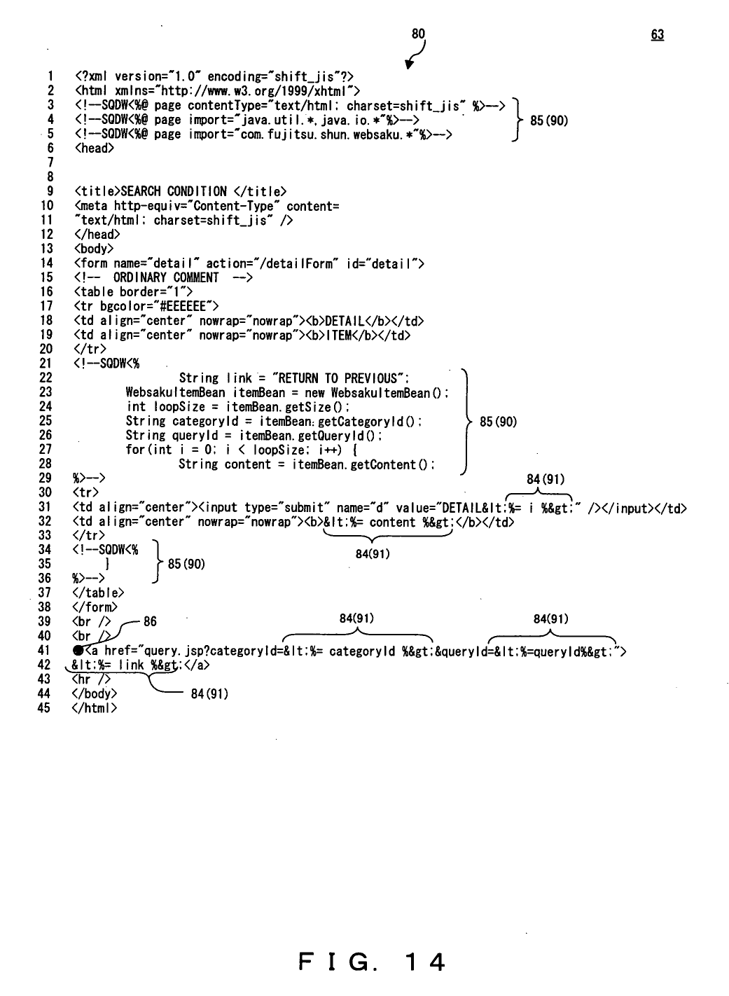

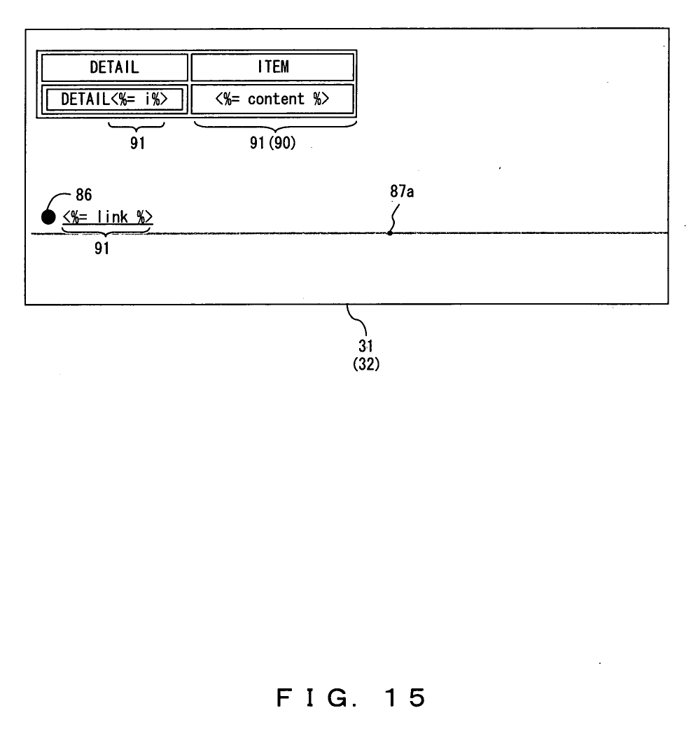

That is, because empty element tags 87, such as “<br>” (i.e., line break) and “<hr>” (i.e., horizontal line), cause errors in XML, they are reformatted by inserting a space “ ” and backslash “/” before the closing “>” so that “<br />” and “<hr />” result, respectively, as exemplified by the line numbers 39, 40 and 43 shown by FIG. 14. FIG. 15 shows the display state of the post-well-formed model HTML document 63 as shown by FIG. 14 after a reformat displayed by the Web browser 32 installed at the maintenance terminal 30.

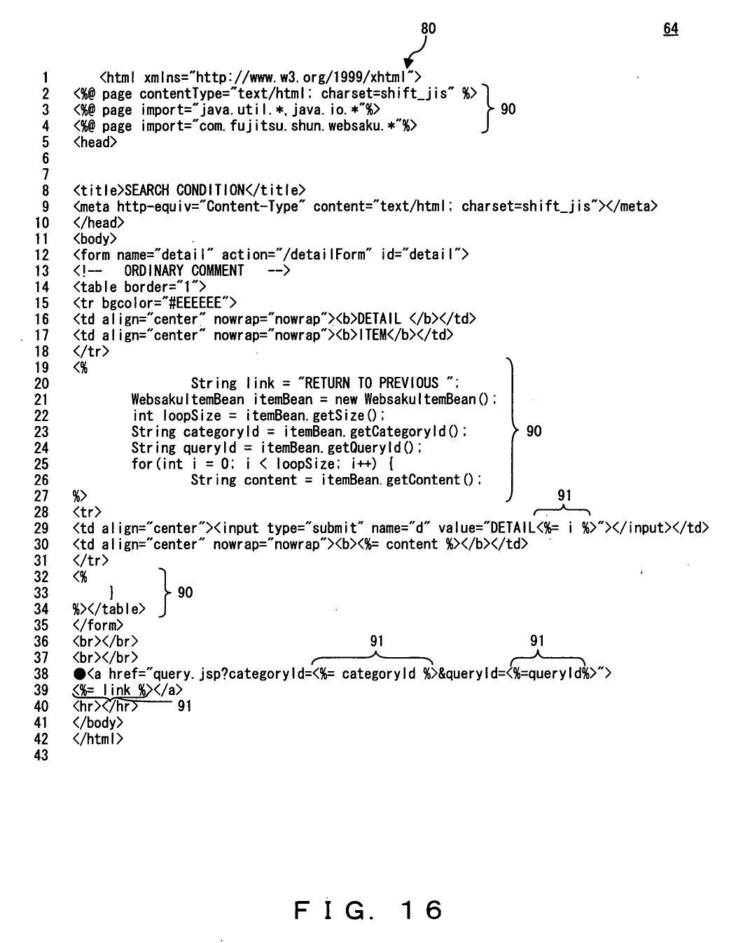

The above is followed by the dynamic page document restore program 22 processing the post-well-formed model HTML document 63 and restoring both the general purpose programming language description 90 which has been converted into a special comment node 85 and the “<” and “>” of the general purpose programming language description 90 which have been converted into escape character strings 84 (step 108), thereby obtaining the post-restore dynamic page document 64 as exemplified by FIG. 16 (step 109).

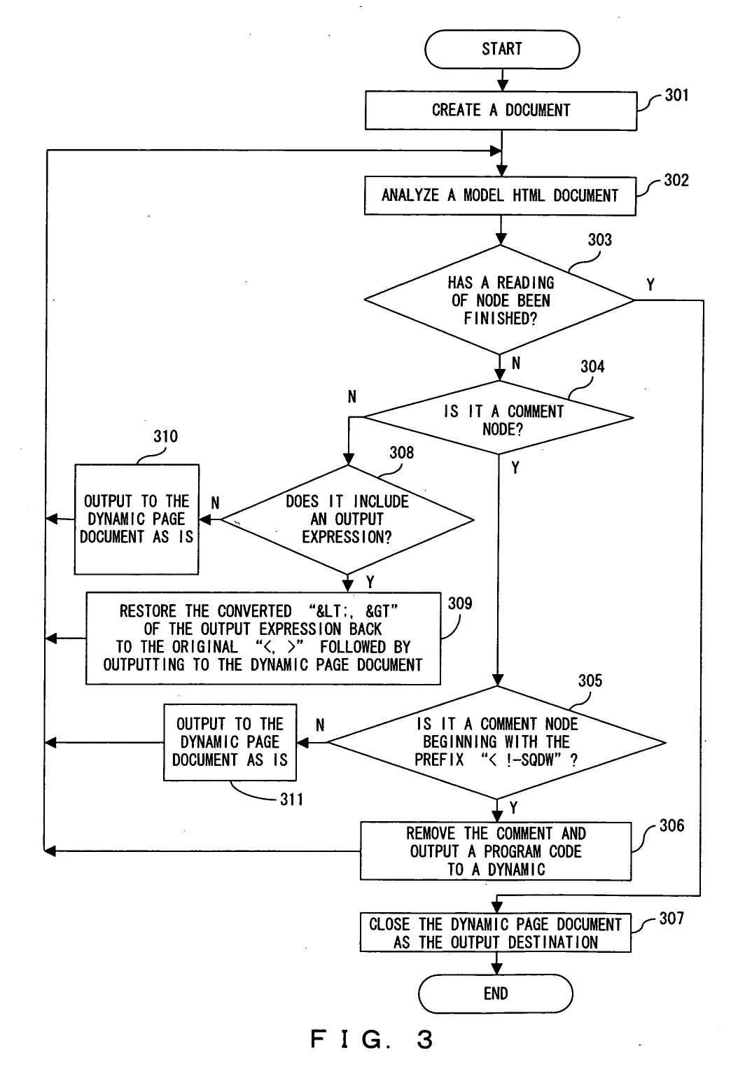

That is, the dynamic page document restore program 22 makes ready an HTML file as the output destination (i.e., post-restore dynamic page document 64) as exemplified by the flow chart in FIG. 3 (step 301), analyzes an input post-well-formed model HTML document 63 based on the node as defined as shown by FIG. 6 (step 302), judges whether or not it is a comment node (step 304) before completing reading the node (step 303) and, if the data is not a comment node of the HTML, further judges whether or not the aforementioned node includes an output expression 91 which has been converted into an escape character string 84 (step 308) and, if an output expression 91 is not included, outputs the data to the post-restore dynamic page document 64, followed by returning to the step 302 (step 310). If the judgment for the step 308 is that an output expression 91 converted into an escape character string 84 is included, reverts the escape character string 84 back to the original “<“or”>”, followed by outputting it to the post-restore dynamic page document 64 and returns to the step 302 (step 309).

If it is judged as a comment node in the step 304, further judges whether or not it is a special comment node 85 (i.e., whether or not a character string “SQDW” which is comment identifier information 85a is included) (step 305) and, if it is not a special comment node 85, outputs the data to the post-restore dynamic page document 64 and returns to the step 302 (step 311). If judged as a special comment node 85 in the step 305, restores the general purpose programming language description 90 which has been embedded in the aforementioned special comment node 85 by removing it, followed by outputting it to the post-restore dynamic page document 64 and returns to the step 302 (step 306). On the other hand, if the judgment for the above described step 303 is that the reading is complete, closes the post-restore dynamic page document 64 (step 307).

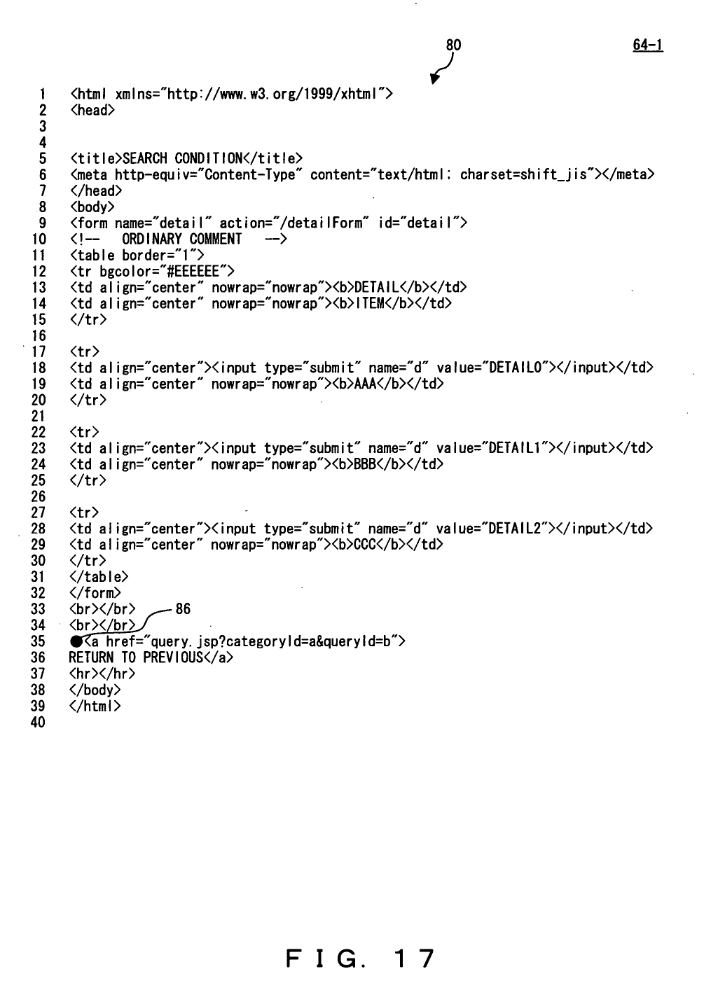

Then, by executing the post-restore dynamic page document 64 by the Web container 11 a post-restore output HTML document 64-1 as exemplified by FIG. 17 is obtained. In the post-restore output HTML document 64-1, the line numbers 17 through 20, 22 through 25, and 27 through 30 are created dynamically by executing the general purpose programming language description 90 of the line numbers 19 through 34 of the post-restore dynamic page document 64.

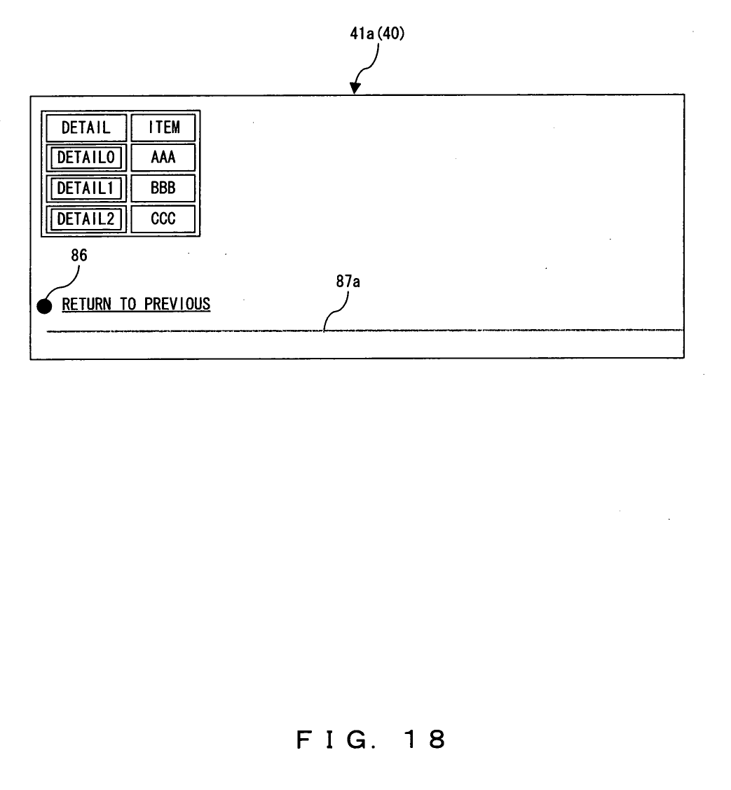

Then, transmitting the post-restore output HTML document 64-1 shown by FIG. 17 to the client apparatus 40 followed by the Web browser 42 therein executing it makes the display 41a comprised by the client apparatus 40 display the screen as exemplified by FIG. 18.

As described above, the present embodiment is configured to edit a model HTML document 61 obtained by converting a general purpose programming language description 90 into a special comment node 85 of the HTML document when editing an original dynamic page document 60 with a mixture of descriptions by the HTML description 80 and general purpose programming language description 90 such as Java language, and therefore it is possible to definitely prevent the general purpose programming language description 90 mixed with the HTML description 80 from becoming the cause of a fault in a sentence structure-check carried out by an XML parser, et cetera, comprised by the HTML editor program 24 which is used for editing the model HTML document 61 for instance, thereby enabling smooth editing/change processing of a model HTML document 61 on the HTML document level.

Furthermore, in the model HTML document 61, since the “<” and “>” included in an output expression 91 of the general purpose programming language description 90 are converted into an escape character string 84 of the HTML document, a display state is not disturbed and the aforementioned output expression 91 is displayed as is in the data display position by the output expression 91 when editing the HTML description 80 included in the model HTML document 61, it is thus possible to change or edit a display style accurately while confirming the output position by the output expression 91 as shown by FIG. 11.

The creation of a post-well-formed model HTML document 63 by processing the post-edit model HTML document 62, obtained after completion of editing the model HTML document 61 by the markup language formatting program 23 and restoration of the parts of the special comment node 85 and escape character strings 84 in the HTML description 80 of the post-well-formed model HTML document 63 by processing the post-well-formed model HTML document 63 by the dynamic page document restore program 22 to obtain a post-restore dynamic page document 64, make it possible to obtain a post-restore dynamic page document 64, whose display style has been changed on the HTML document level, from the original dynamic page document 60 without being conscious of the logic of the general purpose programming language description 90.

That is it is possible to create, from the original dynamic page document 60, various post-restore dynamic page documents 64 with common logic by the general purpose programming language description 90 and different display styles by the HTML description 80, without requiring knowledge of the general purpose programming language description 90.

For instance, design personnel are enabled to modify the design, by the HTML description 80 with minimal consciousness of the program (i.e., general purpose programming language description 90), of an original dynamic page document 60, which has been created by the programming personnel writing the general purpose programming language description 90 and design personnel taking responsibility for the HTML description 80, so as to store the result as the post-restore dynamic page document 64.

As described above, the present embodiment enables the creation of a model HTML document 61 from the original dynamic page document 60 without a change of the general purpose programming language description 90 (i.e., logic), and design personnel with little knowledge of the programming to customize the design based simply on the model HTML document 61 so as to create plural kinds of post-well-formed model HTML documents 63 separately for various purposes by meeting respective requirements.

And when only a part of the design needs to be changed, it is only necessary to modifying the model HTML document 61, instead of modifying the created post-restore dynamic page documents 64 one by one, thereby reducing a coding volume.

And applying a format conforming to XML by the markup language formatting program 23 makes it possible to describe a tag in a design part without being conscious of the XML format when creating an original dynamic page document 60, hence improving the work efficiency.

Furthermore, if program code such as the general purpose programming language description 90 is within a model HTML document 61, make it to the special comment node 85 of the HTML, and therefore display is not disturbed by the general purpose programming language description 90, thus enabling the confirmation of its content by a preview at a glance and ease of design modification.

Incidentally, if a CDATA section is used to ensure the output expression 91 is well-formed in lieu of the escape character string 84 as with the present embodiment, an HTML description 80 in the area surrounded by the CDATA section is not displayed and therefore changing (i.e., editing) the HTML description 80 while confirming the display state becomes very difficult, thus the benefit of the present embodiment is not gained.

The above described processing by the markup language formatting program 23 may be carried out in a discretionary sequence vis-à-vis the respective processing by the model HTML document program 21 and the dynamic page document restore program 22.

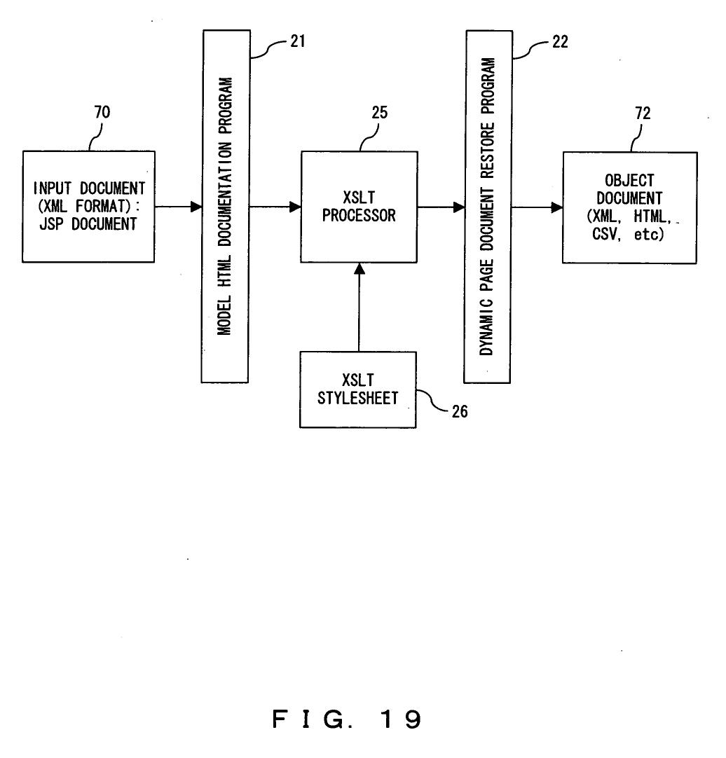

The next description is of a modified example of the present embodiment while referring to FIG. 19. XSLT (Extensible Stylesheet Language Transformation) is known as a technique for outputting an XML document conforming to the XML standard which includes the language specification of HTML. In order to apply the XSLT technique to dynamic page document and check its input data, the data must be converted to ensure it is well-formed in advance, as there is a concern that due to the general purpose programming language description 90 being mixed into the HTML description 80 a fault may occur as described above.

Accordingly, in the following example, the descriptions are of the case of carrying out pre-processing by the above described model HTML document program 21 and post-processing by the dynamic page document restore program 22 and markup language formatting program 23 before and after the XSLT, when converting a dynamic page document by using the XSLT processor 25 in the Web application development system 20 according to the present embodiment.

FIG. 19 is a conceptual diagram showing an example of XSLT processing carried out by the XSLT processor 25 of the Web application development system 20.

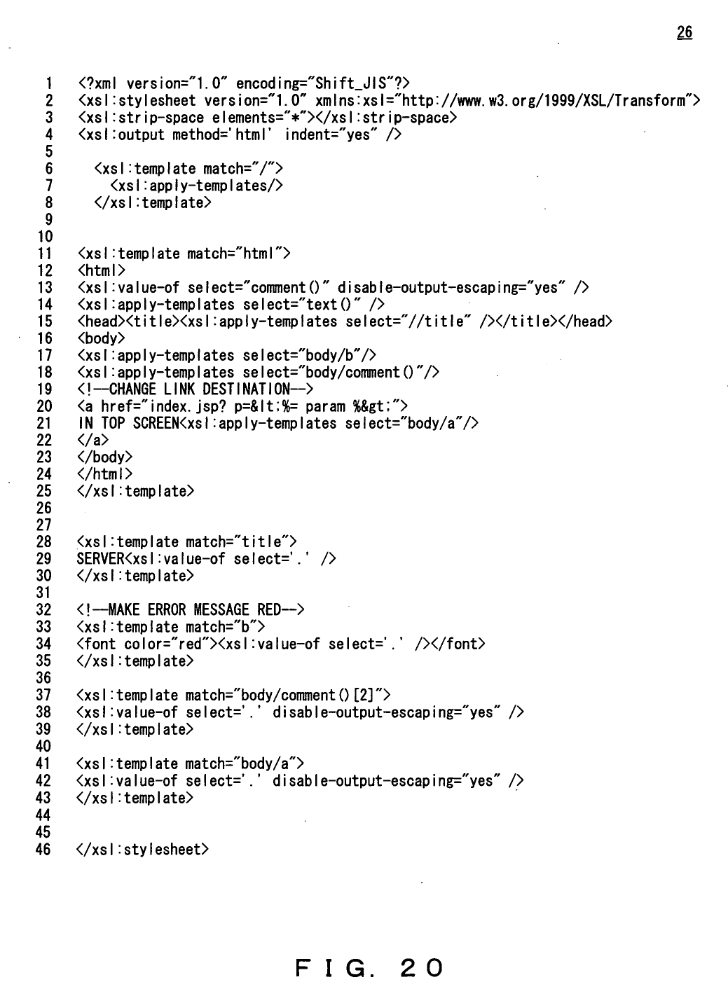

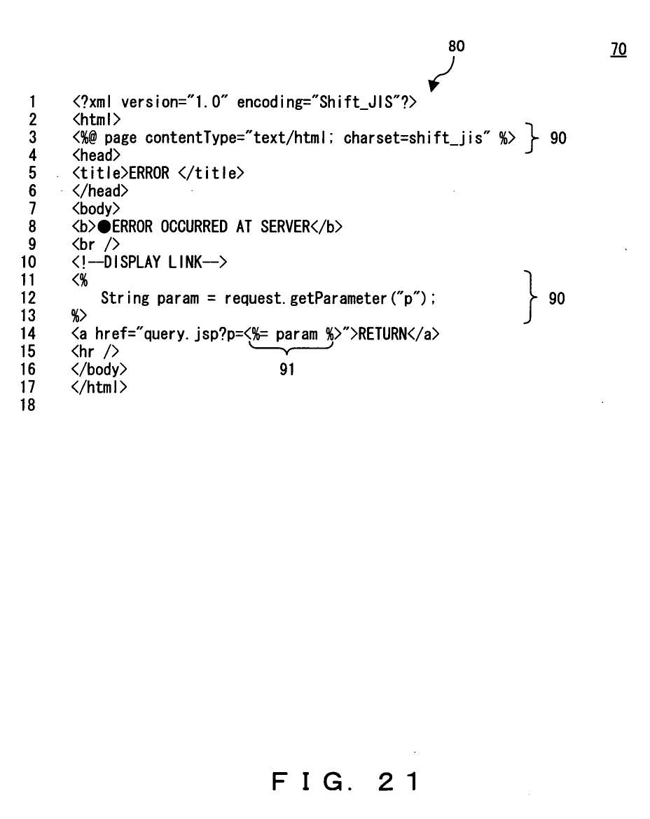

This example shows the case of finally converting an original dynamic page document 70 as shown by FIG. 21 into a object document 72 by using the XSLT Stylesheet 26 exemplified by FIG. 20.

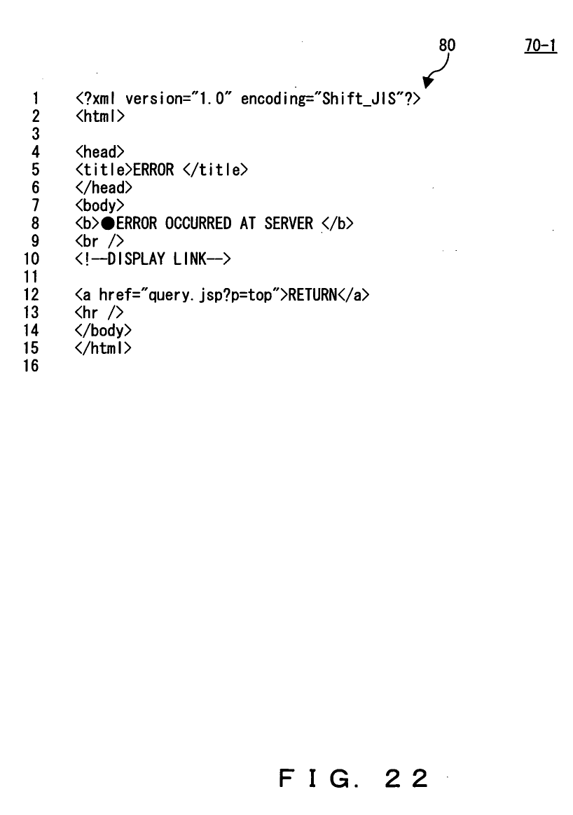

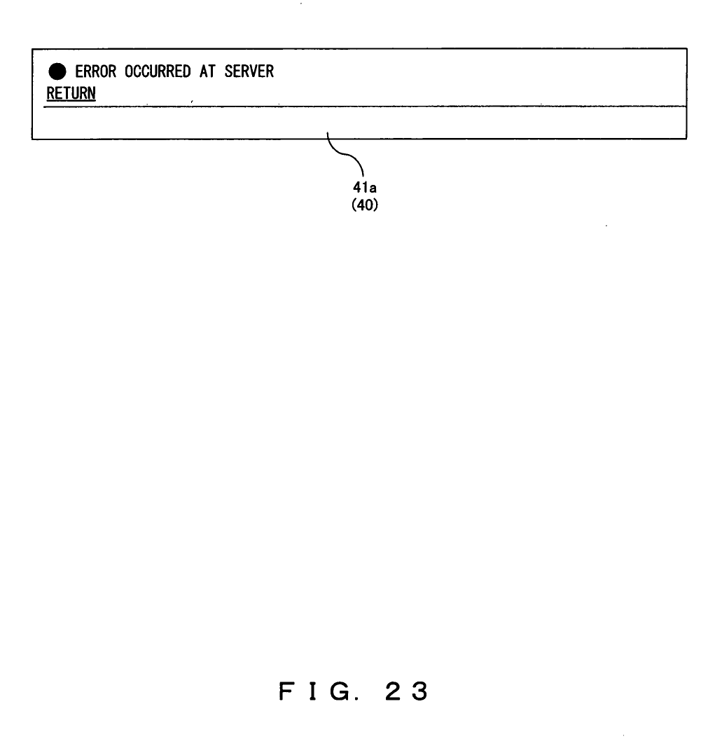

The original dynamic page document 70 is for dynamically creating an original output HTML document 70-1 displaying an error message as exemplified by FIG. 22. FIG. 23 shows the display state of the original output HTML document 70-1 in the Web browser 42 on the client apparatus 40.

That is, in the original dynamic page document 70 shown by FIG. 21, the general purpose programming language description 90 is described in the line numbers 3, and 11 through 13, while the HTML description 80 is described in the other line numbers. Note that an output expression 91 is embedded in the HTML description 80 of line number 14.

In the example of the original dynamic page document 70, if an error occurs on the server executing the original dynamic page document 70, the error message of line number 8 is output and, at the same time, information obtained in a variable “param” by the general purpose programming language description 90 on the line number 12 is output dynamically as a return link destination shown by line number 14.

In the XSLT Stylesheet 26, a definition is made so that, if a character string “server” is detected in the error message within the original dynamic page document 70, the character string “server” is added in front of the “error” of the title on the line number 5 (i.e., the line numbers 28 through 30 in the XSLT Stylesheet 26) and further the content is rewritten to output so as to display the error message on the line number 8 in red (i.e., the line numbers 32 through 35 in the XSLT Stylesheet 26).

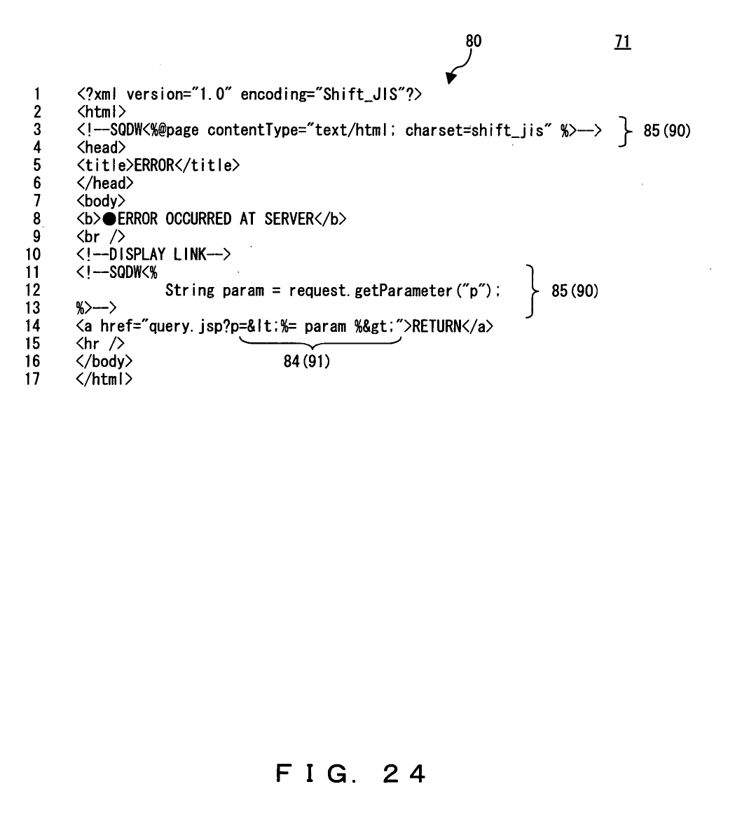

The present embodiment is configured to convert the general purpose programming language description 90 part to a comment by using the special comment node 85 in the model HTML document program 21 and at the same time to convert the output expression 91 into an escape character string 84, prior to a conversion carried out by the XSLT processor 25 based on the XSLT Stylesheet 26. The conversion result is a normalized text document 71 shown by FIG. 24.

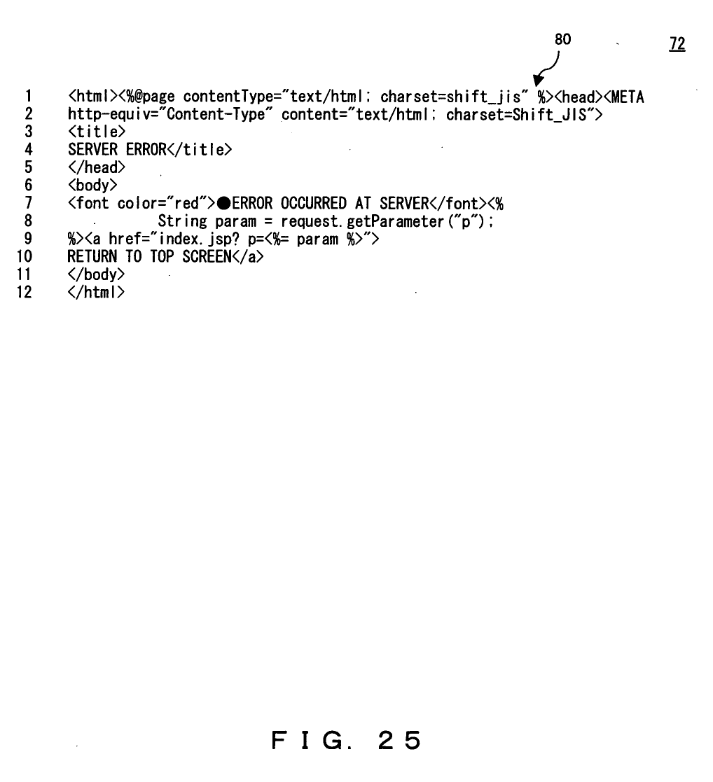

Then, executing the above described conversion processing on the normalized text document 71 based on the XSLT Stylesheet 26 and further carrying out restore processing (i.e., removal of the special comment node 85 and restoration of the escape character string 84) results in the object document 72 shown by FIG. 25. In the object document 72, the title part is changed to “server error” and a color specification for displaying red is added to the display part of the error message on line number 7. Also, the link to the return destination is changed to the top screen as seen on line number 10.

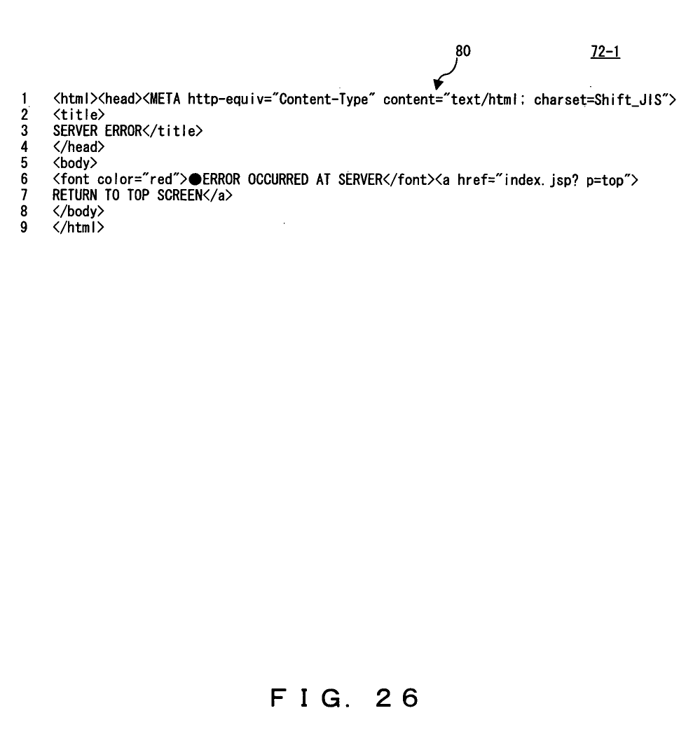

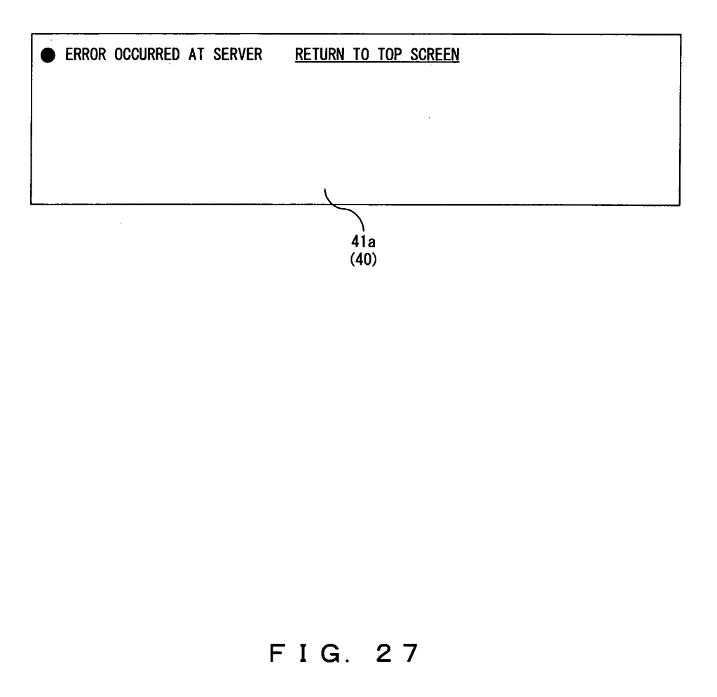

Then, executing the object document 72 by the Web container 11 creates dynamically an object document 72-1 as exemplified by FIG. 26, and transmitting the object document 72-1 to the client apparatus 40 makes the Web browser 42 installed thereby perform error display in the display 41a as exemplified by FIG. 27.

As such, the cases of modified examples shown by FIG. 19 and thereafter highlight the benefits of gaining accurate conversion results without conversion errors even when making a processing system such as the XSLT processor 25 comprising the XML parser of its input system process a document with a mixture of descriptions by the HTML description 80, such as the original dynamic page document 70, and general purpose programming language description 90.

Needless to say that the present invention can be changed in various ways within the scope thereof and is not limited by the above described embodiments.

The present invention enables the improvement of development efficiency and maintenance efficiency of dynamic page documents.

The present invention also makes it possible to convert accurately a document with a mixture of descriptions by first and second languages by a third language as a medium.

What is claimed is:

1. A computer readable storage medium storing a document processing program for making a computer process a document with a mixture of descriptions by first and second languages, wherein the program makes the computer carry out at least one of
a first process of converting the description by the second language into comment syntax of the first language in a state where identifier information is added; and
a second process of converting the description by the second language into an escape character string defined by the first language.

2. The computer readable storage medium storing a document processing program according to claim 1, wherein
said first language is Hyper Text Markup Language, said second language is a general purpose programming language and said document is a dynamic page document.

3. A computer readable storage medium storing a document processing program for making a computer process a document with a mixture of description by first and second languages, wherein the program makes the computer carry out at least one of
a first process of restoring, to the description by the second language, the description by the second language which is embedded in comment syntax of the first language in a state where identifier information is added, and
a second process of restoring, to a pre-conversion state, said description by the second language which is converted to an escape character string defined by the first language.

4. The computer readable storage medium storing a document processing program according to claim 3, wherein the program makes a computer further carry out
a third process of converting said description by said first language into a description by a third language, wherein
the first language is Hyper Text Markup Language, said second language is a general purpose programming language, the third language is Extensible Markup Language and said document is a dynamic page document.

5. The computer readable storage medium storing a document processing program according to claim 3, wherein the program makes a computer carry out
a third process of converting said description by said first language to a description by a third language after making the computer carry out at least one of said first process and said second process.

6. A document processing method for processing a document with a mixture of descriptions by first and second languages, comprising:
carrying out at least one of a first process of converting the description by the second language into comment syntax of the first language in a state where identifier information is added and a second process of converting the description by the second language into an escape character string defined by the first language; and
carrying out at least one of
a third process of restoring, to the description by the second language, the description by the second language which is embedded in comment syntax to the first language in a state where identifier information is added,
a fourth process of restoring, to a pre-conversion state, the description by the second language which is converted to an escape character string defined by the first language, and
a fifth process of converting the description by the first language to a description by a third language.

7. The document processing method according to claim 6, further comprising
changing a display aspect of said document accomplished by said description by said first language by changing the description therein, between said converting and restoring process.

8. The document processing method according to claim 6, wherein
said first language is Hyper Text Markup Language, said second language is a general purpose programming language, said third language is. Extensible Markup Language and said document is a dynamic page document.
